(19) United States
(12) Patent Application Publication
(10) Pub. No.: US 2010/0110078 A1
(43) Pub. Date: May 6, 2010

(54) METHOD AND COMPUTER PROGRAM PRODUCT FOR PLOTTING DISTRIBUTION AREA OF DATA POINTS IN SCATTER DIAGRAM

(75) Inventor: Hirokazu YANAI, Osaka (JP)

Correspondence Address: COOPER & DUNHAM, LLP, 30 Rockefeller Plaza, 20th Floor, NEW YORK, NY, 10112, US

(73) Assignee: RICOH COMPANY, LTD., Tokyo (JP)

(21) Appl. No.: 12/607,461

(22) Filed: Oct. 28, 2009

(30) Foreign Application Priority Data
Oct. 30, 2008 (JP) 2008-279466

(51) Int. Cl. G06T 11/20

(52) U.S. Cl. 345/440

(57) ABSTRACT

A method for plotting a distribution area of a plurality of data points each having two paired variables in a scatter diagram includes (a) dividing a distribution of data points into at least two division areas in one or more radial directions of the distribution of data points from an arbitrary first central dividing point and selecting a data point having a longest distance from the first central dividing point in each of the division areas as a representative point of the distribution of data points, and (b) plotting a distribution area representing line by sequentially connecting the selected representative points in respective division areas.

### BACKGROUND OF THE INVENTION

1. Field of the Invention

The present invention generally relates to a method for plotting a distribution area of data points in a scatter diagram.

2. Description of the Related Art

A scatter diagram is often used to analyze and represent relationships between two variables of paired data. The relationships between the two variables of paired data can often be represented by a regression line or a regression curve in the scatter diagram, from which the relationships can be expressed as the numerical values. For example, Japanese Patent No. 3639636, Japanese Patent No. 3944439, and Japanese Patent Application Laid-Open No. 2007-248198 each disclose a method for representing a characteristic of collection of data points in the scatter diagram. If the collections of data points need to be classified by different layers, plural layers of distributions composed of the collections of data points can be expressed by differentiating colors or shapes of the dots representing data points in a scatter diagram.

As described above, the scatter diagram is suitable for representing a correlation between two variables of paired data. However, if a scatter diagram contains numerous layers representing the variables and also numerous data points (dots), the dots representing data points may be overlapped, thereby making it difficult to perceive the feature of distribution in each layer. Likewise, if the scatter diagram that contains a few layers representing the variables is reduced in size, dots representing data points are also decreased in size, thereby also making it difficult to perceive the feature of distribution in each layer. In order to overcome such challenges, there is a method for drawing a probability ellipse for each layer of variables in a scatter diagram. However, a typical probability ellipse does not accurately represent actual distributions of data.

### SUMMARY OF THE INVENTION

Accordingly, embodiments of the present invention may provide a novel and useful method for drawing a distribution area of data points in a scatter diagram solving one or more of the problems discussed above.

According to an embodiment of the invention, there is provided a method for plotting a distribution area of a plurality of data points composed of two paired variables in a scatter diagram. The method includes: (a) dividing a distribution of data points into at least two division areas in one or more radial directions of the distribution of data points from an arbitrary first central dividing point and selecting a data point having a longest distance from the first central dividing point in each of the division areas as a representative point of the distribution of data points; and (b) plotting a distribution area representing line by sequentially connecting the selected representative points in respective division areas.

The scatter diagram herein indicates a type of diagram to display values for two paired variables for a set of data as a collection of data points, each having the value of one variable determining the position on the horizontal axis and the value of the other variable determining the position on the vertical axis in planar coordinates. The scatter diagram is also called a correlation diagram.

In the aforementioned step of (b), for example, the distribution area representing line is plotted by sequentially connecting the selected representative points in an order such that the plotted distribution area representing line has no intersection. In the step of (b), all the other representative points are connected from each of the representative points to plot the distribution area representing line.

In the aforementioned step (a), a first central dividing point is one of a center of the distribution of data points and a centroid of the distribution of data points. In addition, a central point of the plural data points indicates a data point having values obtained by adding the maximum value and the minimum value of the two paired variables together and dividing the sum by two. In addition, the central point of the plural data points indicates a data point having values obtained by adding the maximum value and the minimum value of the two paired variables together and dividing the sum by two.

Further, in the step of (a), provided that there is a division area that includes no data point, the first central dividing point is selected as a representative point in the division area that includes no data point. Alternatively, even though there is an area that includes no data points, the first central dividing point may not have to be assigned as a representative point.

In addition, in the step of (a), for example, in a case where a regression line through the data points is further provided, a line to define the division areas is set so as to form a predetermined angle to the regression line.

In the step of (a), after the selection of the representative point in the each of the division areas, in a case where the at least two division areas that are adjacently arranged are set as examination areas, a data point having a vector having the first central dividing point as an origin and one of the data points as an end point and having a greatest magnitude of a vector component in a direction of a dividing line dividing the distribution of data points into the at least two division areas and extending from the first central dividing point is selected as an additional representative point in the examination areas among the data points each having a vector having the first central dividing point as an origin and each data point as an end point and each having a greater magnitude of a vector component in the direction of the dividing line dividing the distribution of data points into the at least two division areas and extending from the first central dividing point than any one of the representative points in the examination areas. Further, in a case where there are two or more data points each having the greatest magnitude of the vector component in the direction of the dividing line dividing the distribution of data points into the at least the two division areas and extending from the first central dividing point in the examination areas, one of the two or more data points that is located closest to the first central dividing point is selected as an additional representative point in the examination areas.

Alternatively, the data points each having the greatest magnitude of a vector component in a direction of a dividing line dividing the distribution of data points into the at least two division areas and extending from the first central dividing point are all selected as representative points.

In the aforementioned step of (a), after the selection of the representative point in the each of the division areas, in a case where there are a plurality of dividing lines each dividing the distribution of data points into a plurality of division areas and each extending from the first central dividing point, a data point having a vector having the first central dividing point as an origin and the data point as an end point and having a greatest magnitude of a vector component in a corresponding one of directions of the dividing lines each dividing the distribution of data points in the plurality of division areas and extending from the first central dividing point is selected as an additional representative point in the corresponding one of the directions of the dividing lines each dividing the distribution of data points into the plurality of division areas and extending from the first central dividing point, among the data points each having a vector having the first central dividing point as an origin and each data point as an end point and each having a greater magnitude of a vector component in the corresponding one of the directions of the dividing lines each dividing the distribution of data points in the plurality of division areas and extending from the first central dividing point than the representative point in the each of the division areas. In addition, when there are two or more data points each having the greatest magnitude of the vector component in the corresponding one of the directions of the dividing lines dividing the distribution of data points into the plurality of division areas and extending from the first central dividing point, one of the two or more data points that is located closest to the first central dividing point is selected as an additional representative point in the corresponding one of the directions of the dividing lines dividing the distribution of data points into the plurality of division areas and extending from the first central dividing point.

Alternatively, the data points each having the greatest magnitude of a vector component in a direction of a dividing line dividing the distribution of data points into the at least two division areas and extending from the first central dividing point are all selected as representative points.

In the step of (a), an additional representative point is selected by applying a different value to the first central dividing point in a plurality of times. In the step of (a), in a case where there is one of the division areas that includes no data point in an initial selection of the representative point in the each of the division areas, a second central dividing point is provided at a position within a division area facing the one of the division areas that includes no data point to select the additional representative point subsequent to the initial selection of the representative point in the each of the division areas. Further, in the step of (a), an additional representative point is selected by applying a different value to the first central dividing point in a plurality of times.

Moreover, the step of (a) further includes selecting a data point having a shortest distance from the first central dividing point as another representative point in each of the division areas.

According to the embodiment, the method for plotting a distribution area of a plurality of data points composed of two paired variables in a scatter diagram further includes: (c) grouping data points having a distance therebetween equal to or shorter than a predetermined distance threshold before carrying out the step of (a), and the steps of (a) and (b) are carried out on each group set in the step of (c) thereafter.

Alternatively, the steps of (a) and (b) are carried out on one of the groups that includes a largest number of data points.

Further, in the step of (b), virtual representative points are each provided corresponding to each of the representative points in a direction in which an outline of the distribution the data points is expanded by a predetermined range, and the distribution area representing line is plotted by sequentially connecting the provided virtual representative points.

According to an embodiment of the invention, there is provided a computer program product for causing a computer to execute the steps of the aforementioned method for plotting a distribution area of a plurality of data points composed of two paired variables in a scatter diagram.

Additional objects and advantages of the embodiments will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

### BRIEF DESCRIPTION OF THE DRAWINGS

FIG. 1 is a flow chart illustrating one example of an embodiment of the invention;

FIG. 2 is a data table partially illustrating data used in the embodiment of the invention;

FIG. 3 is a scatter diagram that represents data shown by the data table in FIG. 2 in dots, in which lines to divide a distribution area of the data represented by dots into four are drawn according to the embodiment of the invention;

FIG. 4 is a scatter diagram in which a distribution area representing line is drawn according to the embodiment of the invention;

FIG. 5 is a scatter diagram that represents data shown by the data table in FIG. 2 in dots, in which lines to divide a distribution area of the data represented by dots into eight are drawn according to another embodiment of the invention;

FIG. 6 is a scatter diagram in which a distribution area representing line is drawn according to another embodiment of the invention;

FIG. 7 is another type of the scatter diagram;

FIG. 8 is a scatter diagram of FIG. 7 in which a distribution area representing line is plotted based on a similar step as in the embodiment described with reference to FIGS. 1 to 4;

FIG. 9 is a scatter diagram of FIG. 7 in which a distribution area representing line is plotted based on a similar step as in the embodiment described with reference to FIGS. 5 to 6;

FIG. 10 is a scatter diagram of FIG. 7 to which lines to divide a distribution of data points into four are drawn such that a certain angle is formed by one of the dividing lines and a regression line;

FIG. 11 is a scatter diagram illustrating a process of selecting additional representative points for outlining a distribution area;

FIG. 12 is a scatter diagram in which a distribution area representing line is drawn by connecting representative points including additional representative points;

FIG. 13 is a scatter diagram that represents data shown by the data table in FIG. 2 in dots, in which lines to divide a distribution area of the data represented by dots into three and a line to indicate the distribution area are drawn;

FIG. 14 is a diagram illustrating one data point selected from the data points in the division area A11 of the scatter diagram of FIG. 13;

FIG. 15 is a diagram illustrating a distribution as a result of applying additional representative points to the distribution of data points of FIG. 13;

FIG. 16 is a scatter diagram in which a distribution area representing line is drawn by connecting the representative points obtained in FIG. 15;

FIG. 17 is a scatter diagram that represents data shown by the data table in FIG. 2 in dots, in which a line to divide a distribution area of the data represented by dots into two is drawn;

FIG. 18 is a scatter diagram in which a distribution area representing line is drawn by connecting the representative points in FIG. 17 and additional representative points obtained based on those of FIG. 17;

FIG. 19 is another type of the scatter diagram;

FIG. 20 is a scatter diagram in which a distribution of data points in FIG. 19 is divided into eight by dividing lines, and a distribution area representing line is drawn over the dividing lines by connecting the representative points;

FIG. 21 is a scatter diagram in which a distribution area representing line is drawn by connecting the representative points obtained in FIG. 20 and an additional representative point obtained based on the central dividing point;

FIG. 22 is a scatter diagram illustrating a process of selecting representative points obtained by setting a second central dividing point based on the data points in FIG. 19;

FIG. 23 is a scatter diagram in which a distribution area representing line is drawn by connecting the representative points obtained in FIG. 20 and FIG. 22;

FIG. 24 is a flow chart illustrating still another embodiment of the invention;

FIG. 25 is a scatter diagram that represents data shown by the data table in FIG. 2 in dots, in which lines to divide a distribution area of the data represented by dots are drawn;

FIG. 26 is a scatter diagram of FIG. 25 in which a distribution area representing line is drawn;

FIG. 27 is a scatter diagram in which virtual representative points are each set corresponding to one of the representative points shown in FIG. 3 in a direction of an outline of the distribution area plotted by the distribution area representing line expanded by a predetermined size, and a distribution area representing line is plotted by sequentially connecting the virtual representative points;

FIG. 28 is an enlarged view of the area enclosed by a square in FIG. 27;

FIG. 29 is a scatter diagram illustrating another example of directions in which virtual representative points are each provided corresponding to one of the representative points;

FIG. 30 is a diagram illustrating one example of an outcome obtained by a wafer test;

FIG. 31 is a diagram of a wafer including a defective chip portion in which representative points and a distribution area representing line obtained by applying the coordinate information of the center of a defective chip group 7 composed of defective ships 5 in FIG. 30 to the method according to the embodiment are shown;

FIG. 32 is a diagram illustrating virtual representative points that are each located at positions at which lines each extend from a centroid of the defective chips 5 of a defective chip group 7 and pass through the representative points each included in a corresponding one of the defective chip 5 to reach the maximum lengths of the respective lines within the defective chips 5, and a distribution area representing line plotted by connecting the virtual representative points;

FIG. 33 is a diagram illustrating virtual representative points that are each located at positions at which the longest distance from the centroid of the defective chips 5 of a defective chip group 7 exists, and a distribution area representing line plotted by connecting the virtual representative points;

FIG. 34 is another type of the scatter diagram;

FIG. 35 is a scatter diagram in which a distribution area representing line is plotted based on a similar step as in the embodiment described with reference to FIGS. 1 to 4;

FIG. 36 is a scatter diagram in which the data points are grouped, and the distribution area representing line that is plotted based on the group having the largest number of data points according to the embodiment described with reference to FIGS. 1 to 4 is shown in FIG. 35;

FIG. 37 is a scatter diagram in which the data points are grouped, and the distribution area representing line that is plotted based on each of the groups according to the embodiment described with reference to FIGS. 1 to 4 is shown in FIG. 35;

FIG. 38 is a scatter diagram representing the numerical data A and B shown in FIG. 2 that are indicated by two layers of attributes Z1 and Z2;

FIG. 39 is a diagram illustrating two distribution area representing lines each outlining a corresponding one of data point groups of the attribute Z1 and the attribute Z2 shown in FIG. 38 according to the embodiment described with reference to FIGS. 1 to 4;

FIG. 40 is a scatter diagram representing the numerical data B and C in relation to the numerical data A shown in FIG. 2 that are indicated by two layers of the numerical data B and C;

FIG. 41 is a diagram illustrating two distribution area representing lines each outlining a corresponding one of data point groups of the numerical data B and C shown in FIG. 40 according to the embodiment described with reference to FIGS. 1 to 4; and

FIG. 42 is a scatter diagram in which the distribution area representing lines are plotted from each one of the representative points to all other representative points shown in FIG. 5.

### DETAILED DESCRIPTION OF THE PREFERRED EMBODIMENTS

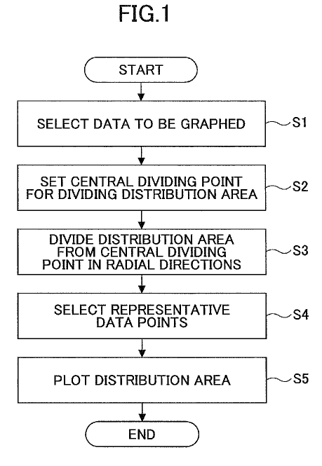

A description is given below, with reference to FIGS. 1 through 42 of embodiments of the present invention.

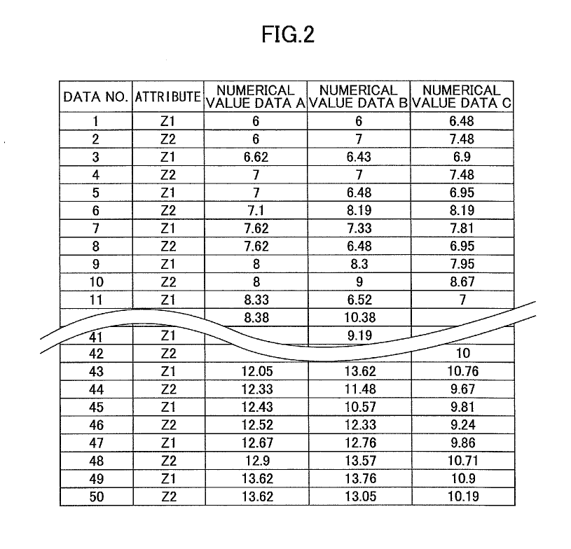

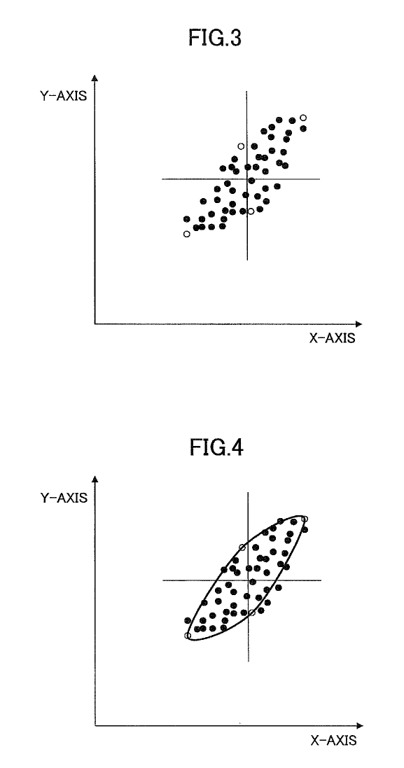

FIG. 1 is a flow chart illustrating an embodiment of the invention, FIG. 2 is a data table partially illustrating data used in the embodiment of the invention, and FIG. 3 is a scatter diagram that represents data shown by the data table in FIG. 2 in dots, in which lines to divide a distribution area of the data represented by dots into four are drawn in this embodiment. FIG. 4 is a scatter diagram that represents data shown by the data table in FIG. 2 in dots, in which lines to divide a distribution area of the data represented by dots into four and a line to indicate the distribution area are drawn in the embodiment. First, the embodiment of the invention is described with reference to FIGS. 1 to 4.

Step 1: Select two related numerical value data to be graphed. In the embodiment, the two numerical value data are denoted by respective numerical value data A and B shown in the data table of FIG. 2. In this embodiment, attributes of the data are not taken into account.

Step 2: Set a central dividing point (first central dividing point) in dividing a distribution area of the numerical value data sets A and B when the numerical value data set A is plotted along an X-axis whereas the numerical value data set B is plotted along a Y-axis. In this embodiment, a centroid of the distribution of data points is defined as the central dividing point in dividing the distribution (hereinafter also called as a “central division point”).

Step S3: Divide the distribution area in radial directions by drawing lines from the central dividing point. In Step 3, the distribution area is divided into four (division areas) by drawing respective lines parallel to the X-axis and to Y-axis to intersect at the central division point (see FIG. 3).

Step 4: Select the data point at a position most distant from the central division point as a representative point in each division area (distribution representative point selection step). In FIGS. 3 and 4, the data points each selected as the representative point in each division area are denoted by circles whereas the data points that are not selected as the representative data points are denoted by solid black dots.

Various methods for selecting a representative point in each division area may be employed. For example, a distance between a first data point and the central division point is computed, and one of the division areas to which the first data point belongs is obtained. Thereafter, the first data point is stored as a representative point candidate, together with the coordinates of the first data point and the computed distance between the first data point and the central division point. Next, a distance between the second data point and the central division point is computed, and one of division areas to which the second data point belongs is obtained. If the division area to which the second data point belongs already includes the representative point candidate, the distance between the second data point and the central division point, and the distance between the representative point candidate (e.g., first data point) and the central division point are compared. If the distance between the second data point and the central division point is larger than the distance between the representative point candidate (i.e., first data point in this example) and the central division point, the second data point is stored as a new representative point, together with the coordinates of the second data point and the distance between the second data point and the central division point. If the distance between the second data point and the central division point is smaller than the distance between the representative point candidate (i.e., first data point) and the central division point, the information on an original representative point candidate (i.e., first data point) remains unchanged. If the distance between the second data point and the central division point is equal to the distance between the representative point (i.e., first data point) candidate and the central division point, the second data point is stored as a representative point candidate, together with the coordinates of the second data point and the distance between the second data point and the central division point are stored, and the information on the original representative point candidate (i.e., first data point) stored as the representative point candidate remains unchanged. If there is no representative point candidate in the division area to which the second data point belongs, the second data point is stored as a representative point candidate, together with the coordinates of the second data point and the distance between the second data point and the central division point. Thereafter, the same process is repeatedly carried out on every data point to obtain a representative point candidate in each division area. Having carried out the process on all the data points, the obtained representative point candidates in respective division areas are each stored as a representative point.

However, the method of selecting a representative point in each division area is not limited thereto. For example, having computed all the distances between each of the data points and the central division point, the data points are grouped by the respective division areas to which any one or more of the data points belong. The distances between each of the data points and the central division area that are obtained for each of the division areas are then compared. Thereafter, the data point that has the longest distance between the data point and the central division point in each division area is selected as a representative point. Alternatively, having grouped the data points by the division areas, all the distances between each of the data points and the central division point are computed in each area. Having computed the distances between the data points and the central division area in the respective division areas, the distances between the data points and the central division area in the respective division areas are compared. Thereafter, the data point that has the longest distance between the data point and the central division point in each division area is selected as a representative point.

It should be noted that a division area that includes no data points can be processed without selecting a representative point. Still in another alternative method, the centroid of data point distribution is defined as the central division point, and the distribution area is equally divided into four in the radial directions to produce four division areas. If there is a division area that includes no data point, the coordinates of the central division point (i.e., central dividing point) can be selected as a representative point in such a division area may be determined.

Step S5: Plot a distribution area representing line by sequentially connecting the representative points (distribution area representing line plotting step). The distribution area representing line is plotted from an origin in a clockwise or counterclockwise direction to sequentially connect or pass through each of the representative points in a corresponding one of adjacent division areas. As a result, the distribution area representing line can be plotted without intersection (see FIG. 4). The distribution area representing line may be a straight line sequentially connecting adjacent representative points; however, it is preferable that the distribution area representing line be a gentle curved line sequentially connecting or passing through the adjacent representative points. Such a curve may be obtained by use of a function of Visual Basic such as “DrawClosedCurve” to thereby obtain a gentle curved line that connects specified dots or data points.

Accordingly, with this method for plotting a distribution area according to the embodiment of the inventions, the distribution of data points may be expressed by enclosing distributed area of data points with a line.

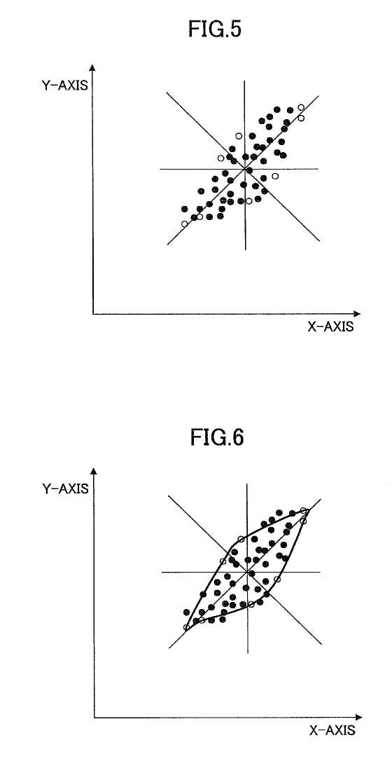

FIG. 5 is a scatter diagram that represents data shown by the data table in FIG. 2 in dots, in which lines to divide a distribution area of the data represented by dots into eight are drawn. FIG. 6 is a scatter diagram that represents data shown by the data table in FIG. 2 in dots, in which lines to divide a distribution area of the data represented by dots into eight and a line to indicate the distribution area are drawn. Below, more embodiments of the invention are described with reference to FIGS. 1, 5, and 6.

As similar to the aforementioned steps S1 and S2, two related numerical value data to be graphed are selected (Step S1) and the central dividing point for dividing the distribution area of the numerical value data sets A and B is set.

In Step S3, the distribution area is divided into eight in radial directions from the central dividing point. In step S3, the distribution area is divided into eight (division areas) by drawing respective lines parallel to the X-axis and to Y-axis to intersect at the central dividing point, and in addition, by drawing diagonal lines to the respective lines parallel to the X-axis and to Y-axis, thereby obtaining eight segments (division areas) each having a 45-degree central angle (see FIG. 5).

In step 4, the data point at a position most distant from the central dividing point in each division area is selected as a representative point. In FIGS. 5 and 6, the data points each selected as a representative point are denoted by circles whereas the data points that are not selected as the representative points are denoted by solid black dots.

In step S5, a line is plotted by sequentially connecting each of the representative points to thereby depict a distribution area representing line. The distribution area representing line is plotted from an origin in a clockwise or counterclockwise direction to sequentially connect or pass through the representative points in adjacent division areas. In this manner, the distribution area representing line can be plotted without intersection (see FIG. 6).

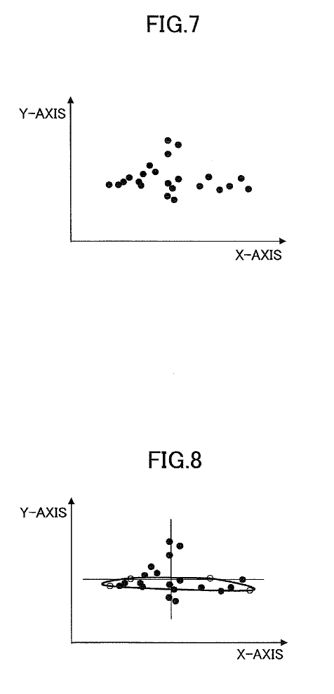

It should be noted that if a line is drawn to divide the distribution such that segments (division areas) each have a large center angle, the distribution area representing line drawn in a distribution may not accurately represent the distribution of data points by following the aforementioned steps alone. An example of such a case can be demonstrated by FIG. 7. As shown in FIG. 7, the centroid of the distribution of data points is defined as the central dividing point for dividing the distribution of data points, the distribution area is divided into four in the radial directions by drawing lines from the central dividing point to produce four segments of division areas, and a representative point is then selected (determined) in each division area. Thereafter, a distribution area representing line is drawn in the distribution of data points by sequentially connecting each of the representative points. An example of such a distribution area representing line composed of a gentle curved line is shown in FIG. 8.

In FIG. 8, a circle represents a representative point in each division area. As illustrated in FIG. 8, there may be a substantial number of data points that largely deviate from the distribution area representing line, which are accordingly excluded from the area shown by the enclosed distribution area representing line.

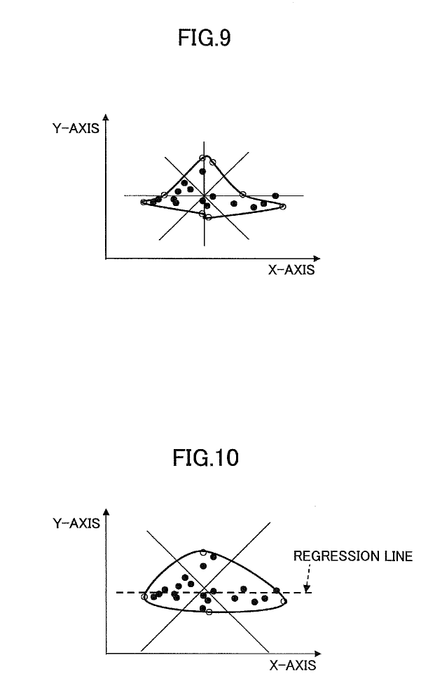

One approach to include such deviated data points within the area defined by the distribution area representing line may be to reduce an angle by which each of the lines divides the distribution (i.e., dividing lines); that is, to increase the number of division areas (segments). In FIG. 9, an angle by which each of the lines is drawn in the radial directions to divide the distribution into eight such that central angles of respective division areas or segments are made smaller than those of the division areas obtained in FIG. 8, and the representative point in each division area is then selected. The representative points obtained in this manner are shown in FIG. 9. In FIG. 9, a circle represents the representative point in each division area. As illustrated in FIG. 9, the distribution area representing line drawn in the scatter diagram can accurately represent the distribution of data points without excluding the substantial number of data points from the distribution area representing line, as illustrated in the example of FIG. 8.

Another approach to include the deviated data points within the enclosed distribution area representing line may be to draw lines to divide the distribution such that each of the segments (division areas) has substantially a large center angle. In FIG. 8, one of the lines that divide the distribution is approximately parallel to the regression line (not shown). By contrast, if the dividing lines are each drawn to form a substantial angle to the regression line, the representative points denoted by the circles can be obtained as illustrated in FIG. 10. As shown in FIG. 10, most of the data points can be enclosed by the distribution area representing line.

Further, still another approach to include the data points within the line may be to select some of the data points that are required for appropriately drawing the distribution area representing line and add such data points as new representative points.

The method of selecting additional representative points is described as follows.

First, two adjacent division areas are defined as examination areas, and a line between the two adjacent division areas extending from the central dividing point (hereinafter also called as “dividing line”) is defined as an examination line. In selecting additional representative points, the magnitude of a vector component of a data point having the central dividing point as an origin and the data point as an end point in a direction of a dividing line dividing the distribution of data points into at least two division areas and extending from the central dividing point can be used as an index. Thus, the magnitude of the aforementioned vector component (i.e., vector component of a data point in the direction of the dividing line dividing the distribution of data points into the two adjacent division areas and extending from the central dividing point) of each data point is computed.

In each of the two adjacent examination areas, the data point having the greatest magnitude of the aforementioned vector component is added as a representative point selected from all the data points that each have the magnitude of the aforementioned vector component greater than any one of the representative points. If there exist two or more data points equally having the greatest magnitude of the aforementioned vector component in the two adjacent examination areas, one of the aforementioned data points having the coordinates closer to the coordinates of the central dividing point is selected as an additional representative point.

In order to compute the magnitude of the aforementioned vector component of the data point, a line intersecting at right angles with the dividing line dividing the distribution of data points into the two division areas and passing through the central dividing point is drawn. This line is defined as an examination line. Examples of the examination lines are shown by L1 and L2 in FIG. 11. With this method, the magnitude of the aforementioned vector component of a data point is determined based on a distance between the data point and the examination line. However, a method of computing the magnitude of the aforementioned vector component of the data point may not be limited to the aforementioned method.

In addition, the representative point having the greatest magnitude of the aforementioned vector component of all the data points in the examination areas may be selected as a comparative representative point. The comparative representative point hereafter means a data point with which the magnitude of the aforementioned vector component of each of the representative points is compared. In this case, among those data points in the examination areas, the data point having the magnitude of the aforementioned vector component greater than the comparative representative point is selected as additional representative point.

Referring to FIG. 11, a process of selecting additional representative points based on the examination line and the comparative representative point is described below. In FIG. 11, A1 to A4 denote four division areas, and T1 to T4 denote representative points corresponding to one of the four division areas A1 to A4.

First, two adjacent division areas A1 and A2 in FIG. 11 are selected as the examination areas. In this case, the examination line is a line L1 in FIG. 11. The line L1 is the same line as one of the dividing lines that divide the distribution of data points to obtain division areas. The representative point T2 is located at a position more distant from the examination line L2 than the representative point T1 based on the examination line L1. That is, the magnitude of the aforementioned vector component of the representative point T2 is greater than that of the aforementioned vector component of the representative point T1 in a direction of a dividing line dividing the distribution of data points into the two adjacent division areas A1 and A2 and extending from the central dividing point based on the examination line L1 (i.e., the representative point T2 has longer distance than the representative point T1 from the examination line L1). Since all the data points excluding the representative point T1 and T2 are located at positions more distant from the representative point T2 based on the examination line L1, the data points excluding the representative points T1 and T2 are found to each have the magnitude of the aforementioned vector component greater than the comparative representative point T2 in the division areas A1 and A2. Among the aforementioned data points each having the magnitude of the aforementioned vector component greater than the comparative representative point T2, the data point T5 is located at a position most distant from the examination line L1, and therefore, the data point T5 has the aforementioned vector component the greatest of all in the division areas A1 and A2. Accordingly, the data point T5 is selected as an additional representative point.

Next, the division areas A2 and A3 are selected as examination areas, and the aforementioned process is repeated. In this case, the examination line is a line L2 shown in FIG. 11. The line L2 is the same line as one of the dividing lines to divide the distribution of data points to obtain division areas. In the division areas A2 and A3, the representative point T3 is located at a position most distant from the examination line L1. Accordingly, there is no data point to be selected as an additional representative point in these division areas A2 and A3.

Subsequently, the division areas A3 and A4 are selected as examination areas, and the aforementioned process is repeated. In this case, the examination line is the line L1 shown in FIG. 11. The representative point T4 is located at a position more distant from the examination line L1 than the representative point T3. Accordingly, the representative point T4 is selected as a comparative representative point. Since the data point T6 is located at a position most distant from the examination line L1 of all the data points located at positions more distant from the representative point T4 selected as a comparative representative point in the examination areas, the data point T6 is selected as an additional representative point.

Next, the division areas A1 and A4 are selected, as examination areas, and the aforementioned process is repeated. In this case, the examination line is the line L2 shown in FIG. 11. In the division areas A1 and A4, the representative point T4 is located at a position most distant from the examination line L1. Accordingly, there is no data point to be selected as additional representative points in these division areas A1 and A4.

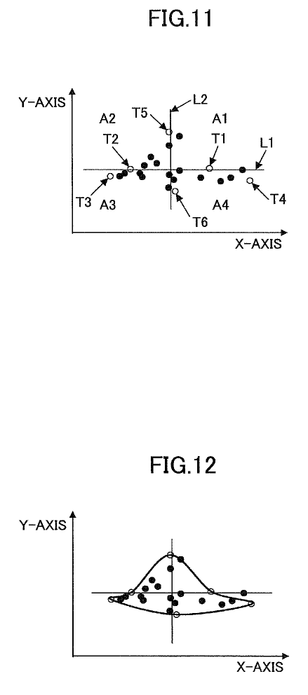

Thus, there are, in total, two data points selected as additional representative points, namely, the representative points T5 and T6. FIG. 12 shows a scatter diagram in which a distribution area representing line composed of a gentle curved line is plotted. The distribution area representing line is plotted by sequentially connecting the representative points from T1 to T6 in the counterclockwise direction, starting from any given one of the representative points including the additional representative points T5 and T6. In this example of FIG. 12, almost all the data points can be enclosed by the distribution area representing line.

In the aforementioned embodiment, a representative point located at a position more distant from the examination line than the other one in the two adjacent division areas is selected as a comparative representative point. However, it may not be necessary to select a comparative representative point in the method for plotting a distribution area according to the embodiment of the invention. In a case where no comparative representative point is selected, the distances between each of the data points and the examination line is compared with the distances between each of the representative points and the examination line within the examination areas, and hence, the data point located at a position most distant from the examination line than any other representative points within the examination areas can be obtained.

It should be noted that a method of selecting additional representative points used in the embodiment of the invention is not limited to the aforementioned method, in which the distribution of data points is divided into four. The distribution of data points may be divided into three. Such a case is described in the following embodiment.

FIG. 13 is a scatter diagram that represents data shown by the data table in FIG. 2 in dots, in which lines to divide a distribution area of the data represented by dots into three and a line to indicate the distribution area are drawn. In FIG. 13, the centroid of the distribution of data points is determined as the central dividing point for dividing the distribution, and the distribution area is equally divided into three in the radial directions to produce three division areas A11 to A13. Thereafter, representative points are each selected in the respective division areas A11 to A13.

As illustrated in FIG. 13, the distribution of data points is represented by a distribution area representing line obtained by sequentially connecting the three representative points each selected in corresponding one of the division areas A11 to A13. However, it is preferable that more data points be selected as additional representative points in order to enclose more data points and hence, plot a more accurate distribution area representing line.

As a method of selecting additional representative points, a method similar to the one used in the aforementioned embodiment may be employed. In this method, the magnitude of a vector component of a data point having the central dividing point as an origin and the data point as an end point in a direction of a dividing line dividing the distribution of data points into the two adjacent division areas and extending from the central dividing point can be used as an index. That is, the magnitude of the aforementioned vector component of the data point may be computed based on the examination line described above.

However, in the example of FIG. 13, it may not be possible to compute the magnitude of the a vector component for each of the data points in a direction of a dividing line dividing the distribution of data points into the division areas A11 and A13 and extending from the central dividing point by simple addition or subtraction of values based on the coordinates of the respective data points and the coordinates of the central dividing point.

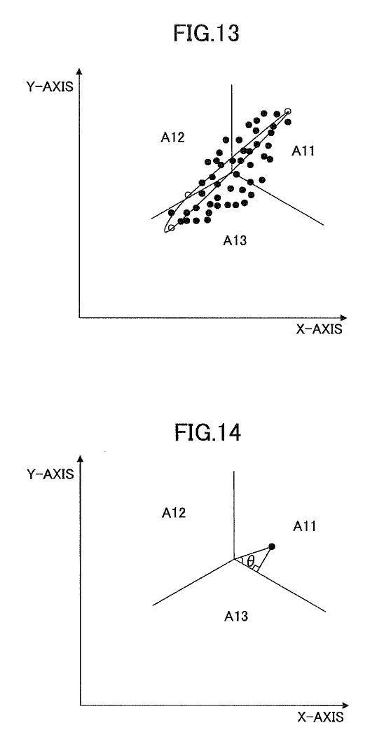

In such cases, the aforementioned vector component of a data point may be computed based on the trigonometrical function. FIG. 14 is a diagram illustrating one data point selected from the data points in the division area A11 of the scatter diagram of FIG. 13. A method of computing the aforementioned vector component of the data point based on the trigonometrical function is described with reference to FIG. 14.

A vector component having the central dividing point as an origin and the data point as an end point in a direction of a dividing line dividing the distribution of data points into the division areas A11 and A13 and extending from the central dividing point corresponds to a vector component at an intersecting point obtained by drawing a line perpendicular to the dividing line dividing the distribution of data points into the division areas A11 and A13 and extending from the central dividing point. Since the division areas A11 to A13 are predetermined, an angle formed based on a data point and the coordinate axes can be obtained based on the coordinate information of each data point.

Accordingly, it is possible to obtain the angle θ formed based on the dividing line dividing the distribution of data points into the division areas A11 and A13 and the vector of a data point having the central dividing point as an origin and the data point as an end point. Thus, the aforementioned vector component of the data point can be computed based on the trigonometrical function to which a distance between the central dividing point and the data point, and an angle θ of the data point are applied.

(Magnitude of vector component of data point in a direction of a dividing line dividing a distribution of data points into division areas and extending from the central dividing point)=(Distance between the central dividing point and data point)*cos θ

Accordingly, the magnitude of the aforementioned vector component of each of the data points in the examination areas can be computed, and the data point having the greatest magnitude of all can be selected as an additional representative point.

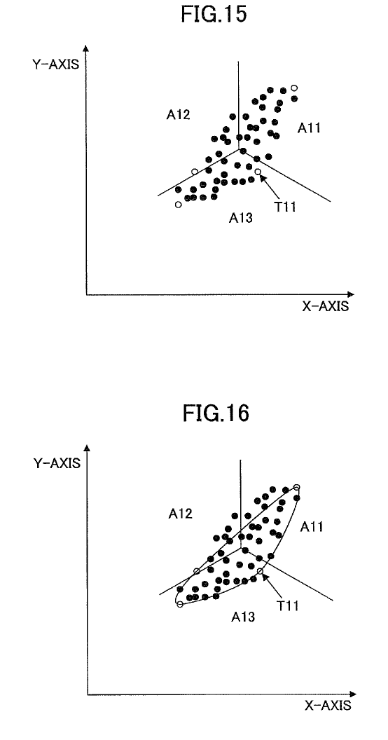

FIG. 15 is a diagram illustrating a distribution obtained by adding a selected data point to the distribution of data points in FIG. 13 as an additional representative point. FIG. 16 is a scatter diagram in which a distribution area representing line is drawn by connecting the representative points obtained in FIG. 15.

There is no additional representative point to be selected in the division areas A11 and A12 as examination areas. Likewise, there is no additional representative point to be selected in the division areas A12 and A13 as examination areas. The data point T11 is selected as an additional representative point in the division areas A11 and A13 as the examination areas. A distribution area representing line illustrated in FIG. 16 can be obtained by sequentially connecting four representative points denoted by the circles in FIG. 15, in either a clockwise or counterclockwise direction starting from one representative point selected as an origin. Thus, the distribution area representing line can be drawn more accurately.

According to the aforementioned method for plotting the distribution area, the examination lines are used to obtain a vector component of each data point in a direction of a dividing line dividing the distribution of data points into two division areas and extending from the central dividing point in the examination areas. However, the examination lines may not have to be used in the aforementioned method. Various methods can be employed for computing the magnitude of the aforementioned vector component for each data point. For example, as illustrated in FIG. 11, when lines to divide the distribution area are set in the X-axis direction and the Y-axis direction, the magnitude of the aforementioned vector component of each of the respective data points can be obtained based on the coordinate components of each of the data points and the central dividing point on the coordinate axis of a dividing line dividing the distribution of data points into the two adjacent division areas and extending from the central dividing point. It should be noted that a method of computing the magnitude of the aforementioned vector component of the respective data points is not limited to the aforementioned method, and various methods can be employed for computing such a vector component of the respective data points.

There may be provided another method of selecting additional representative points. Another method of selecting additional representative points is described as follows (hereinafter also referred to as a “second method of selecting additional representative points”). In selecting additional representative points, the magnitude of a vector component of a data point having the central dividing point as an origin and the data point as an end point in a direction of a dividing line dividing the distribution of data points into the division areas and extending from the central dividing point can be used as an index. It should be noted that the concept of the examination area described above is not employed. The data point having the greatest magnitude of the aforementioned vector component is selected as a representative point, of all the data points each having the aforementioned vector component greater than the representative points. In addition, since there are plural directions in which dividing lines each dividing the distribution of data points into plural division areas and extending from the central dividing point, an additional representative point is selected for each direction. If there are two or more data points that satisfy the condition as a representative point for each direction, one data point that is located closer to the central dividing point than the other is selected as an additional representative point.

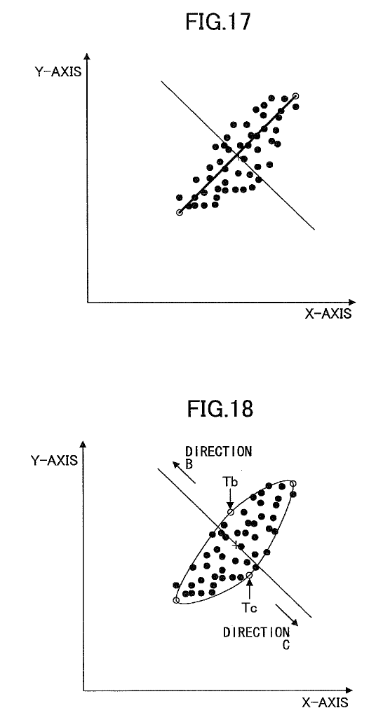

FIG. 17 is a scatter diagram that represents data shown by the data table in FIG. 2 in dots, in which a line to divide a distribution area of the data represented by dots into two and a line to indicate the distribution area are drawn. As illustrated in FIG. 17, a data point distribution is expressed by a distribution area representing line obtained by connecting the two representative points obtained in the respective division areas. However, it is preferable that more data points be selected as additional representative points in order to enclose more data points and hence, plot a more accurate distribution area representing line.

FIG. 18 is a scatter diagram in which a distribution area representing line is plotted by sequentially connecting the representative points in FIG. 17 and additional representative points obtained based on those of FIG. 17. In the following embodiment, the second method of selecting additional representative points is employed. Specifically, the plural directions in which the distribution of data points is divided are indicated by respective directions B and C in FIG. 18, and additional representative points are selected for each of the directions B and C.

It should be noted that in the second method of selecting additional representative points, the examination line described above may be used for selecting the data points as additional representative points. However, if the plural directions are not perpendicular to or parallel to one of the coordinate axes that divides the distribution of data points as illustrated in FIGS. 17 and 18, it may not be possible to compute the magnitude of the aforementioned vector components of the respective data points by simple addition or subtraction of values based on the coordinates of the respective data points and the coordinates of the central dividing point.

In such a case, it is preferable to use the aforementioned trigonometrical function to compute the magnitude of the aforementioned vector component of the data point. The data point Tb is determined as an additional representative point for the direction B based on the method of computing the magnitude of the aforementioned vector component of the data point with the trigonometrical function. Likewise, the data point Tc is determined as an additional representative point for the direction C. A distribution area representing line illustrated in FIG. 18 can be plotted by sequentially connecting four representative points, namely, the representative points and additional representative points shown in FIG. 17, in either a clockwise or counterclockwise direction starting from one representative point selected as an origin. Thus, the distribution area representing line can be drawn more accurately.

It should be noted that the distribution of data points is divided into two in this method; however, the distribution of data points may be divided into two or more.

In the description of Step S4, if any of the division areas include no data points, the coordinates of the central dividing point is used as an additional representative point or no additional representative points are added to the entire distribution. However, alternatively, another central dividing point (hereinafter called “second central dividing point”) may be provided, and thereafter steps S3 and S4 are carried out based on the second central dividing point. Basically, any one of the data points can be selected as the second central dividing point. It is preferable that the second central dividing point can be provided for the division areas diagonally facing the respective division areas that include no data points in the initial selection step of selecting a representative point.

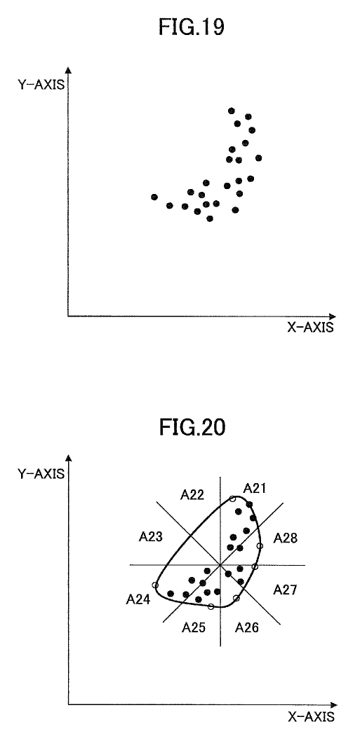

FIG. 19 is another example of the scatter diagram according to the embodiment of the invention. FIG. 20 is a diagram illustrating an outcome obtained by carrying out the steps S1 to S5 shown in FIG. 1 on the data points illustrated in FIG. 19. FIG. 20 is a diagram illustrating a distribution area that is divided into eight division areas A21 to A28. In FIG. 20, since the division areas A22 and A23 include no data points, the division areas A22 and A23 include no representative points. As can be seen from FIG. 20, in the case where there are the division areas that include no representative points, a distribution area representing line may be plotted to enclose a large portion of the areas that include no data points.

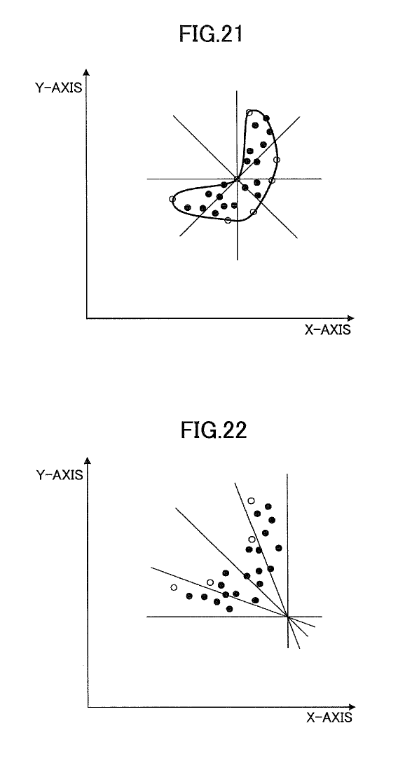

FIG. 21 illustrates a distribution area representing line that is plotted when the coordinates of the central dividing point is selected as an additional representative point and added to the representative points in FIG. 20. In this case, the coordinates of the central dividing point is selected as the additional representative point. As a result, the more accurate distribution area representing line may be plotted even though there are no data points in the division area A22 and A23.

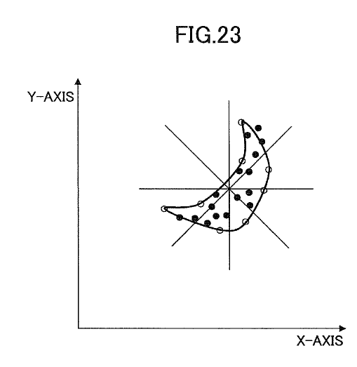

An example of setting the second central dividing point is described with reference to FIGS. 19, 20, 22, and 23. The centroid of the distribution of data points in FIG. 19 is determined as the central dividing point, and the steps S1 to S4 described with reference to FIG. 1 are carried out. As a result, the representative points (circles) are obtained as shown in FIG. 20. Since the division areas A22 and A23 include no data points, a second central dividing point is provided at a position within the division areas A26 and A27 that are diagonally facing the division areas A22 and A23, respectively. As shown in FIG. 21, the second central dividing point is set on an extended line of the dividing lines dividing between the division areas A26 and A27 shown in FIG. 20. The representative points (circles) shown in FIG. 22 are obtained by carrying out the steps S1 to S4 described with reference to FIG. 1 based on the second central dividing point. The distribution of data points in FIG. 21 is shifted in a minus direction of the X-axis and a plus direction of the Y-axis based on the second central dividing point, and the distribution is then equally divided into four division areas. In this example, there is one overlapping representative point when carrying out the selecting representative point step for the second time and the distribution area representing line shown in FIG. 23 is obtained by carrying out the step S5.

Thus, even though there are division areas that include no data points, the more accurate distribution area representing line can be plotted by either setting the coordinates of the central dividing point as an additional representative point, or setting the coordinates of the second central dividing point as an additional representative point.

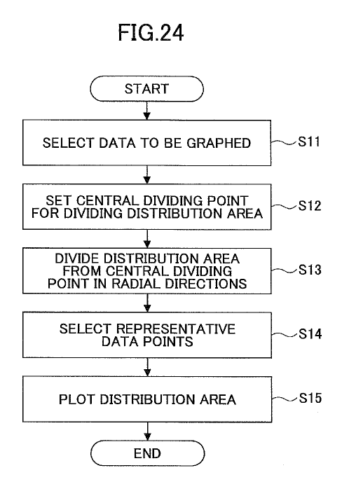

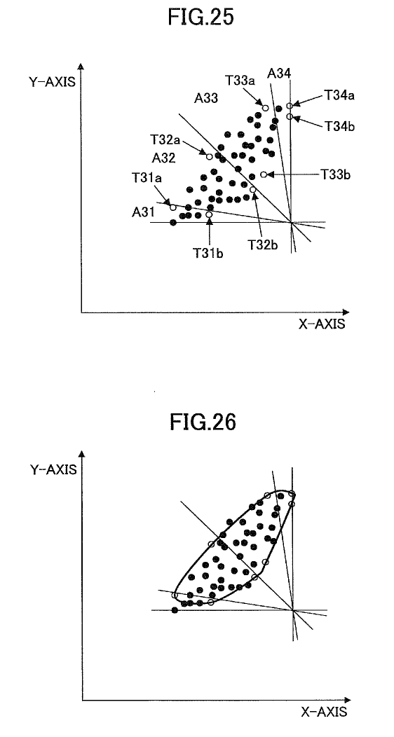

FIG. 24 is a flow chart illustrating still another embodiment of the invention. FIG. 25 is a scatter diagram that represents data shown by the data table in FIG. 2 in dots, in which lines to divide a distribution area of the data represented by dots according to this embodiment of the invention are drawn. FIG. 26 is a scatter diagram that represents data shown by the data table in FIG. 2 in dots, in which lines to divide a distribution area of the data represented by dots and a line to indicate the distribution area are drawn according to this embodiment of the invention. The embodiment of the invention is described with reference to FIGS. 24 to 26.

Step 11: Select two related sets of numerical data to be graphed. In this embodiment, the two sets of numerical data are described as numerical value data sets A and B shown in the data table of FIG. 2. It should be noted that attributes of the data are not taken into account.

Step 12: Set a central dividing point to divide a distribution area of the numerical value data sets A and B when the numerical value data set A is plotted along an X-axis whereas the numerical value data set B is plotted along a Y-axis. Basically, the central dividing point may be situated at any arbitrary point on the X-axis and Y-axis coordinates. It is preferable that the central dividing point be situated outside of an outer circumferential line obtained by connecting all of the data points in the scatter diagram. In this embodiment, the central dividing point is obtained based on the maximum value of the numerical data A and the minimum value of the numerical data B.

Step S13: Divide the distribution area in radial directions from the central dividing point. In this embodiment, in the scatter diagram composed of the numerical data A and B, (see FIG. 25), an area is formed by a line extending from the central dividing point in the minus direction of the X-axis and a line extending from the central dividing point in the plus direction of the Y-axis, with an angle formed at the intersection of the two lines of 90 degrees. The area is then divided into four in the radial directions by drawing lines from the central dividing point. The obtained four division areas are denoted by A31 to A34.

Step 14: Compute the data point at a position most distant from the central dividing point and the data point at a position closest to the central dividing point in each division area as representative points (distribution representative point selection step). In FIGS. 25 and 26, the data points selected as the representative points are denoted by circles whereas data points that are not selected as the representative points are denoted by solid black dots. As described above, there are two types of representative points obtained in each of the division areas A31 to A34. Specifically, the representative points situated at positions most distant from the central dividing point are denoted by T31a, T32a, T33a, and T34a and the representative points at positions closest to the central dividing point are denoted by T31b, T32b, T33b, and T34b.

Step S15: Plot a distribution area representing line by sequentially connecting the representative points (distribution area representing line plotting step). The distribution area representing line is plotted from an origin in a clockwise or counterclockwise direction to sequentially connect or pass through representative points in adjacent division areas. As a result, the distribution area representing line is plotted without intersection (see FIG. 26). In order to prevent the distribution area representing line from intersecting itself when connecting the representative points to draw the distribution area representing line, it is desirable that the representative points be connected in the order of the representative points T32a, T33a, T34a, T34b, T34b, T33b, T32b, T31b, and T31a. The distribution area representing line may be a straight line; however, it is preferable that the distribution area representing line be a gentle curve line that connects or passes through the aforementioned representative points, as shown in FIG. 26. Thus, in the method for plotting a distribution area according to the embodiment of the invention, the distribution of data points can be expressed by enclosing distributed data points by a line.

It should be noted that the method of adding the representative points described with reference to FIG. 11 may also be applied to this embodiment. When a distribution is divided into plural division areas, there may be a case where one or more division areas each include only one data point. In this case, either one of the representative point located at a position most distant from the central dividing point and the representative point located at a position closest to the central dividing point can be selected as an additional representative point. If, on the other hand, the division area including only one data point is one of the division areas located in the middle, it is preferable that the distribution area representing line be plotted by connecting the representative points of the division areas located at both ends without connecting the representative points in the division areas located between the division areas located at both ends.

In the embodiment described with reference to FIGS. 24 to 26, the second central dividing point is set to the distribution of data points and a representative point corresponding to the second central dividing point is added to the distribution of data points. The distribution area representing line can thereafter be plotted by sequentially connecting the representative points including the additional representative point determined based on the second central dividing point. For example, in the scatter diagram in FIG. 25, the point obtained based on the minimum value of the numerical data A and the maximum value of the numerical data B of FIG. 2 can be selected as the second central dividing point.

In the embodiments of the invention, if the coordinates of the actual data points are used as the coordinates of the representative points, the distribution area representing line that outlines a distribution of data points may be overlapped with some of the circles indicating the data points including the representative points in the scatter diagram. In order to avoid this overlap, virtual representative points are set corresponding to the respective representative points in directions in which to an outline of the distribution area representing line is expanded by a predetermined range. In the aforementioned embodiment, this process is carried out from the steps S5 to S15.

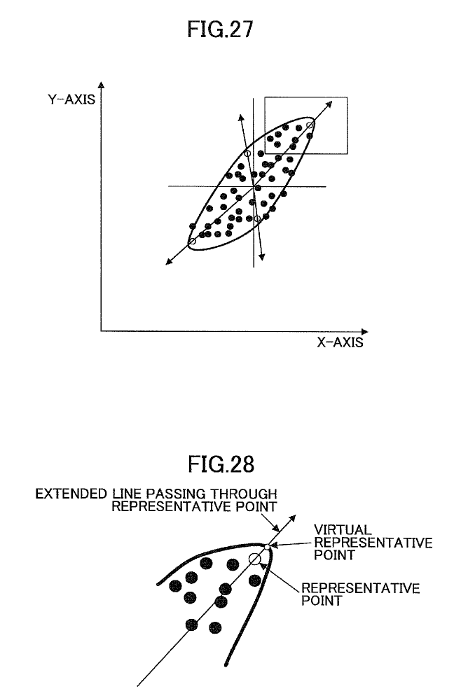

An example of the directions in which the virtual representative point are provided include directions in which lines are drawn from the central dividing point to pass through respective representative points. FIG. 28 is an enlarged view of the area enclosed by a square in FIG. 27. The distances between the respective combinations of representative points and virtual representative points corresponding to the representative points can be predetermined. However, it is preferable that the distances between the respective representative points and the virtual representative points corresponding to the respective representative points be variable according to the size of the scatter diagram.

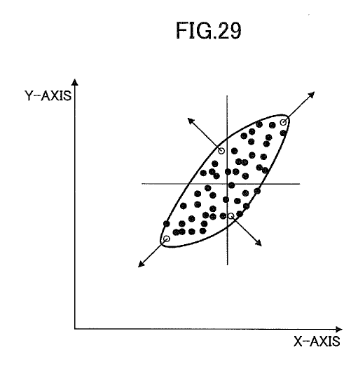

The directions in which the virtual representative points are provided may not have to be directions in which lines are drawn from the center or the centroid of the distribution of data points, however, may be directions in which the outline of the distribution area drawn by the distribution area representing line is expanded by the predetermined range. For example, as shown in FIG. 29, such directions may be 45 degrees from a line to a corresponding one of the representative points in the respective division areas. As described above, in the embodiment in which neither the central dividing point nor centroid is used for determining the aforementioned directions in which virtual respective representative points are provided, it is preferable that the directions in which virtual representative points are provided corresponding to the representative points simply be set for the respective division areas.

A specific example of providing the virtual representative points in plotting the distribution area includes plotting a concentrated distribution of defective chips obtained as a result of a test on wafers in a wafer test step in a semiconductor device fabrication process. In the semiconductor device fabrication process, semiconductor devices called “chips” are formed in a matrix-type configuration on a silicon substrate wafer. The wafer test step in the semiconductor device fabrication process includes performing an electric test on each of the chips on the wafer to discriminate the chips that satisfies a predetermined electric standard from the chips that do not. In general, the chips that satisfy the predetermined electric standard are determined as non-defective chips whereas those that do not satisfy the predetermined electric standard are determined as defective chips.

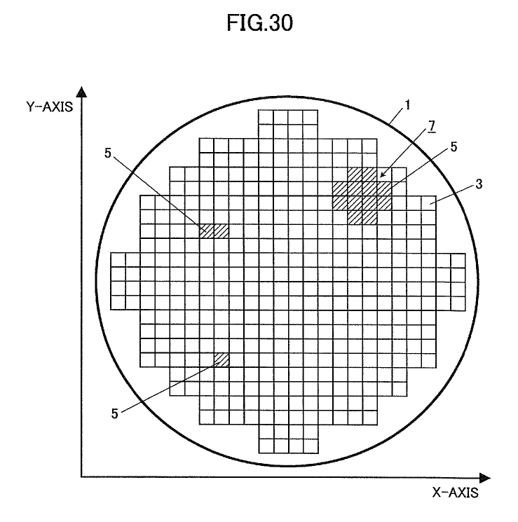

FIG. 30 is a diagram illustrating one example of an outcome obtained by the wafer test. As illustrated in FIG. 30, the chips are disposed in a matrix-type configuration on a silicon substrate wafer 1 (hereinafter also called “wafer”). The position of each chip on the wafer 1 is defined based on information on the coordinates of X-axis and those of Y-axis. In FIG. 30, no pattern is provided with non-defective chips 3. In contrast, a pattern formed by diagonal lines is provided with the defective chips 5.

It is preferable that fewer defective chips be contained in the semiconductor device fabrication process. Thus, an activity to reduce defective chips is constantly performed in the semiconductor device fabrication process. The activity to reduce the defective chips includes obtaining a distribution of the defective chips on the wafer. It is more likely to find a method of reducing defective chips if there is an area in which the defective chips are intensively distributed on the wafer.

For example, the defective chips may be grouped based on a condition of the distribution of the defective chips on the wafer 1. As disclosed in Japanese Patent No. 3888938, the defective chips on the wafer are grouped into one or more groups and whether the defective chips are intensively distributed specifically to one or more areas is examined based on the number of defective chips found in each group. With this method, the defective chips 5 in FIG. 5 are grouped into three.

A group of the defective chips in the distribution determined to be in the same group based on the condition of the distribution of the defective chips can be expressed by the application of information on the X-axis coordinates and the Y-axis coordinates of the respective defective chips to the method for plotting a distribution area according to an embodiment of the invention. In this method, a one-to-one aspect ratio may be applied to the coordinate information on the chip array as the coordinate information of a chip. However, the length of a planar chip may not necessarily be equal to the width of the same planar chip. It is preferable that the coordinate information on the chip array not be dependent on the metric system or shape of the chip. For example, provided that the center of wafer is determined as an origin, the coordinates (X, Y) of the center of each chip expressed by the metric system may be employed as the coordinate information on the chip array.

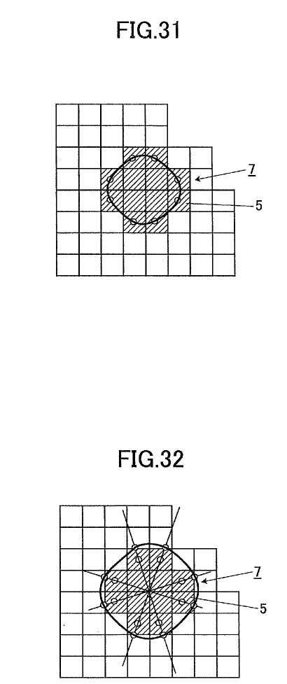

Subsequently, representative points may be computed by applying the coordinate information on the center of the defective chip 5 of a defective chip group 7 in FIG. 30 to the method for plotting a distribution area according to an embodiment of the invention. FIG. 31 shows a distribution of the defective chips 5 of the defective chip group 7. In FIG. 31, the representative points are denoted by circles. A distribution area representing line is obtained by sequentially connecting the representative points.

In each of the defective chips 5 having the respective representative points, a virtual representative point is determined as a data point at a position where the longest line extending from a centroid of the distribution of the defective chips 5 and passing through the representative point is obtained. The distribution of the defective chips 5 is shown in FIG. 32. In FIG. 32, the virtual representative points are also shown by the circles. A distribution area representing line is obtained by sequentially connecting the virtual representative points.

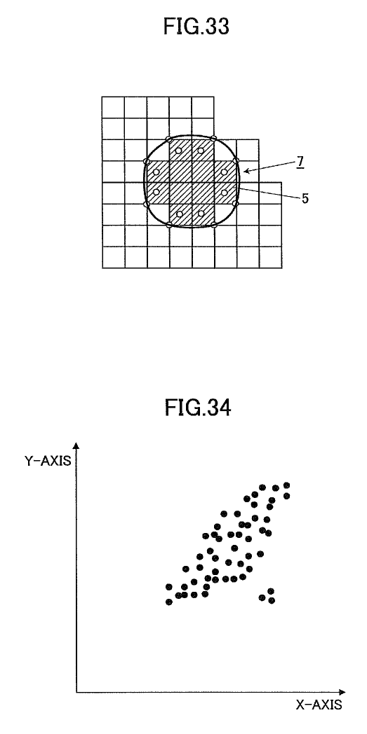

Alternatively, in each of the defective chips 5 having the respective representative points, a virtual representative point is determined as a data point at a position most distant from the centroid of the distribution of the defective chips 5. The distribution of the defective chips 5 is shown in FIG. 33. In FIG. 33, the virtual representative points are also shown by the circles. A distribution area representing line is obtained by sequentially connecting the virtual representative points.

As shown in FIG. 31, the distribution area representing line may not fully enclose the defective chips 5 of the defective chip group 7. By contrast, as shown in FIGS. 32 and 33, the virtual representative points are provided corresponding to the respective representative points in directions in which the distribution area representing line is expanded by a predetermined range, and the distribution area representing line is plotted by sequentially connecting the virtual representative points. As a result, the distribution area representing line can fully enclose the defective chips 5 of the defective chip group 7.

Accordingly, it is be preferable that the virtual representative points be provided for the respective representative points and the distribution of the data points be expressed by a curved line that passes through the virtual representative points.

Further, the semiconductor device fabrication process includes an inspection step that inspects whether foreign matters or defective devices are included. The foreign matters or defective devices in the inspection step may also be expressed by the coordinates (X, Y) information, and hence, a distribution of the foreign materials or defective devices may be expressed by applying the coordinates (X, Y) information to the method for plotting a distribution area.

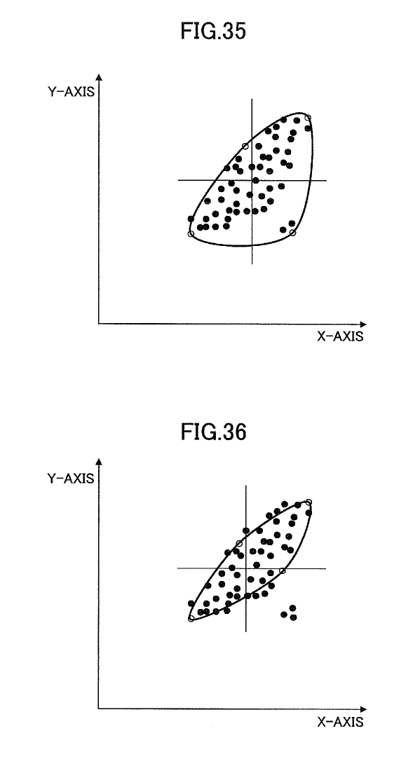

With any of the aforementioned methods according to the embodiment of the invention, a distribution of data points illustrated in FIG. 34 may be outlined by a distribution area representing line that sequentially connects three unique data points. FIG. 35 illustrates one example of a distribution area representing line that represents the distribution of data points shown in FIG. 34 according to the embodiment described with reference to FIGS. 1 to 4.

In a case where the distribution area representing line is desired to be plotted by connecting the representative points excluding the aforementioned three unique data points, mutual distances between the data points are each computed and the data points each having the mutual distance between the two corresponding data points equal to or shorter than a predetermined distance threshold are grouped before carrying out a distribution representative points selecting step, a distribution area plotting step is carried out to plot the distribution area representing line by connecting the data points of the group having the largest number of data points. The mutual distances herein indicate the distances between each of combinations of two data points. In this method, the distance threshold may be a predetermined value, however, may be a variable value according to the distribution of data points. For example, the minimum mutual distances between the data points are respectively computed, and the distance threshold may be determined as the mean of the obtained minimum mutual distances between the data points+3σ (σ is the standard deviation).

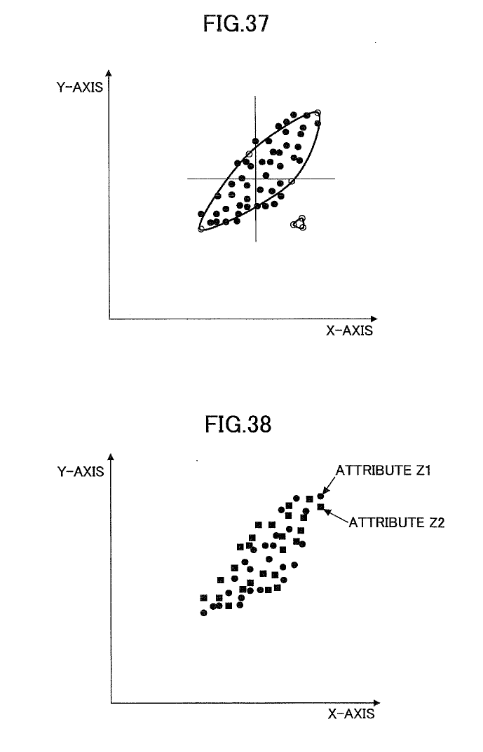

The data points shown in FIG. 34 are grouped, and the distribution area representing line that is plotted based on the group having the largest number of data points based on the embodiment described with reference to FIGS. 1 to 4 is shown in FIG. 36. The data points of FIG. 34 are grouped, and the distribution area representing line that is plotted based on each of the group having the largest number of data points according to the embodiment described with reference to FIGS. 1 to 4 is shown in FIG. 37 according to the embodiment described with reference to FIGS. 1 to 4.

FIG. 38 is a scatter diagram representing the numerical data A and B shown in FIG. 2 that are indicated by two layers of attributes Z1 and Z2. In FIG. 38, the data points each having the attribute Z1 are denoted by solid dots and the data points each having the attribute Z2 are denoted by solid squares. As illustrated in FIG. 38, if the groups of data point each having one of the attributes Z1 and Z2 are distributed in an overlapped area, it may be difficult to discriminate the group having the attribute Z1 from the group having the attribute Z2.

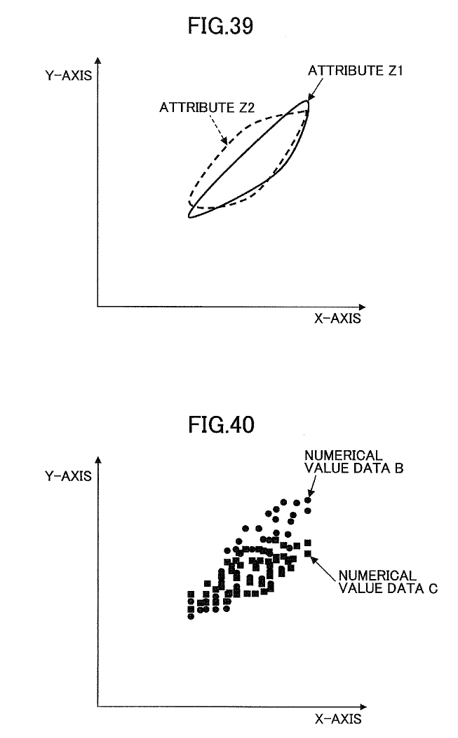

FIG. 39 is a diagram illustrating two types of distribution area representing lines each outlining a corresponding one of the data point group with the attribute Z1 and the data point group with the attribute Z2 as shown in FIG. 38 according to the embodiment described with reference to FIGS. 1 to 4. A solid line represents the distribution area representing line indicating a distribution of the data points each having the attribute Z1, whereas a broken line represents the distribution area representing line indicating a distribution of the data points each having the attribute Z2. As shown in FIG. 39, two types of distributions of data points grouped by the attributes Z1 and Z2 are indicated by two different types of distribution area representing lines. Accordingly, two types of distributions composed of data points with the respective attributes Z1 and Z2 can be clearly distinguished.

FIG. 40 is a scatter diagram representing the numerical data B and C in relation to the numerical data A shown in FIG. 2 that are indicated by two layers of attributes Z1 and Z2. In FIG. 40, the data points of the numerical data B are denoted by solid dots and the data points of the numerical data C are denoted by solid squares. In FIG. 40, since distributions of two types of data points each representing one of the numerical data B and C are overlapped, it may be difficult to discriminate the distribution of the data points representing the numerical data B from that of the data points representing the numerical data C.

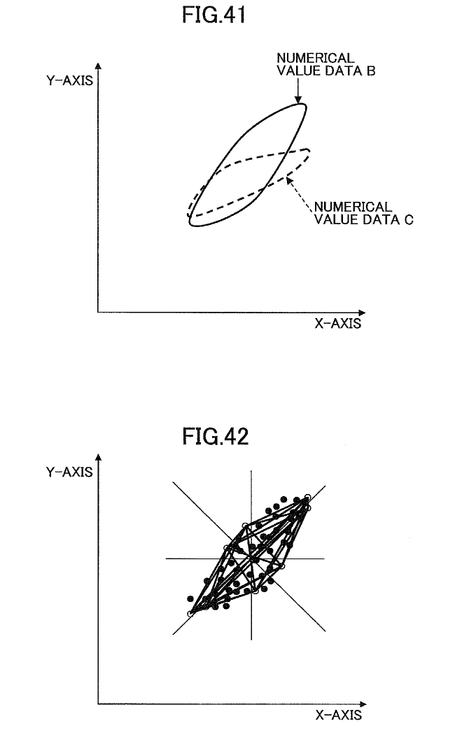

FIG. 41 is a diagram illustrating two types of distribution area representing lines each outlining a corresponding one of the data point group with the numerical data B and the data point group with the numerical data C shown in FIG. 40 according to the embodiment described with reference to FIGS. 1 to 4. A solid line represents the distribution area representing line indicating a distribution of data points of the numerical data B, whereas a broken line represents the distribution area representing line indicating a distribution of data points of the numerical data C. As shown in FIG. 41, two types of distributions of data points grouped by the numerical data B and C are indicated by two different types of distribution area representing lines. Accordingly, two types of distributions composed of the data points with the respective numerical data B and C can be clearly indicated. Thus, the method for plotting a distribution area is particularly effective in expressing two or more types of data points in overlapped layers in the scatter diagram.

In the aforementioned embodiments, the distribution area representing line is plotted by sequentially connecting the representative points in the order such that the plotted distribution area representing line has no intersection. For example, based on the representative points shown in FIG. 5, the distribution area representing lines may each be plotted from each of the representative points to all other representative points as shown in FIG. 42. The distribution of data points may appropriately be outlined in this method. In FIG. 42, the mutual representative points are connected by a straight line; however, may be connected by a curved line as similar to the example of FIG. 6.

The aforementioned steps according to the embodiment can be realized by causing a computer to execute a computer program developed based on the aforementioned steps.

The embodiments of the invention described so far are not limited thereto. Various modifications may be made within the scope of the inventions described in the claims. For example, in the aforementioned embodiments, the distribution area is divided by drawing lines from the central dividing point in radial directions. However, if polar coordinates are set based on the central dividing point, and the distribution of data points are divided by drawing lines from the polar coordinates, a result similar to the aforementioned embodiment may be obtained.

It should be noted that the scatter diagram is used in each of the embodiments; however, it may not be necessary for the steps of each embodiment of the invention to be provided with the scatter diagram that have already been plotted. That is, each step in the embodiment of the invention only needs plural data composed of two paired variables. Moreover, the scattered diagram used in the embodiments includes the dividing lines to show the division areas for convenience; however, these dividing lines may not necessarily be shown in each step of the embodiment.

Further, in a case where there is no representative point in the division area, subsequent processes may be carried out without the representative point in the corresponding division area. In the embodiments of the invention, the number of division areas is not particularly specified. In addition, sizes of the respective division areas may not have to be equal.

According to the embodiments of the invention, there is provided a method for plotting a distribution area of a plurality of data points composed of two paired variables in a scatter diagram. The method includes (a) dividing the distribution of data points into at least two division areas in one or more radial directions of the distribution of data points from an arbitrary first central dividing point and selecting a data point having a longest distance from the first central dividing point as a representative point in each of the division areas, and (b) plotting a distribution area representing line by sequentially connecting the selected representative points in the respective areas.

In the method for plotting a distribution area of the data points according to the embodiments, since the distribution area representing line is plotted by sequentially connecting the selected representative points in an order such that the plotted distribution area representing line has no intersection, an outline of the distribution area of the data points may be plotted. However, the distribution area of the data points may also be expressed by connecting all the other representative points from each one of the representative points.

In the method for plotting a distribution area of the data points according to the embodiments, when causing a computer to execute each of the steps in the embodiments, the first central dividing point may be set one of a center of the distribution of the distribution of data points and a centroid of the distribution of the distribution of data points in the step of (a). In this manner, an appropriate first central dividing point may be automatically set for each of the plural data without making an operator to manually set the first central dividing point.

Moreover, in the method for plotting a distribution area of the data points according to the embodiments, provided that there is a division area that includes no data point, the first central dividing point is selected as a representative point in the division area that includes no data point in the step of (a). Accordingly, the distribution area of the data points is appropriately expressed as compared with a case where the first central dividing point is not selected as a representative point in the division area that includes no data point in the step of (a).

In the method for plotting a distribution area of the data points according to the embodiments, there is a case where dividing lines dividing the distribution of data points into the division areas are overlapped with a regression line through plural data points, inappropriate representative points may be selected.

Accordingly, in the step of (a), for example, in such a case where the regression line through the data points is further provided, a line to define the division areas is set so as to form a predetermined angle to the regression line, thereby lowering a case where inappropriate representative points are selected.

In addition, in the step of (a), after the selection of the representative point in the each of the division areas, in a case where the at least two division areas that are adjacently arranged are set as examination areas, a data point having a vector component having the first central dividing point as an origin and one of the data points as an end point and having a greatest magnitude of a vector component in a direction of a dividing line dividing the distribution of data points into the at least two division areas and extending from the first central dividing point is selected as an additional representative point in the examination areas among the data points each having a vector component having the first central dividing point as an origin and each data point as an endpoint and each having a greater magnitude of a vector component in the direction of the dividing line dividing the distribution of data points into the at least two division areas and extending from the first central dividing point than any one of the representative points in the examination areas. In this manner, the distribution area of the data points may be appropriately be expressed.

Further, in the step of (a), in a case where there are two or more data points each having the greatest magnitude of the vector component in the direction of the dividing line dividing the distribution of data points into the at least the two division areas and extending from the first central dividing point in the examination areas, one of the two or more data points that is located closest to the first central dividing point is selected as an additional representative point in the examination areas. In this manner, a data point located closest to the dividing line dividing the two or division areas may be selected as an additional representative point in the examination areas, thereby appropriately expressing the distribution area of the data points.

Moreover, in the step of (a), in a case where there are a plurality of dividing lines each dividing the distribution of data points into a plurality of division areas and each extending from the first central dividing point, a data point having the first central dividing point as an origin and the data point as an end point and having a greatest magnitude of a vector component in a corresponding one of directions of the dividing lines each dividing the distribution of data points in the plurality of division areas and extending from the first central dividing point is selected as an additional representative point in the corresponding one of the directions of the dividing lines each dividing the distribution of data points into the plurality of division areas and extending from the first central dividing point, among the data points each having a vector component having the first central dividing point as an origin and each data point as an endpoint and each having a greater magnitude of a vector component in the corresponding one of the directions of the dividing lines each dividing the distribution of data points in the plurality of division areas and extending from the first central dividing point than the representative point in the each of the division areas, after the selection of the representative point in the each of the division areas. In this manner, the distribution area of the data points may be expressed further appropriately.

Further, in the step of (a), in a case where there are two or more data points each having the greatest magnitude of the vector component in the direction of the dividing line dividing the distribution of data points into the at least the two division areas and extending from the first central dividing point in the examination areas, one of the two or more data points that is located closest to the first central dividing point is selected as an additional representative point in the examination areas. In this manner, a data point located closest to the dividing line dividing the two or division areas may be selected as an additional representative point in the examination areas, thereby appropriately expressing the distribution area of the data points.

In the step of (a), an additional representative point is selected by applying a different value to the central dividing point in a plurality of times. In this manner, the distribution area of the data points may appropriately be expressed by carrying out the subsequent step of (b).

This process is particularly effective when there is a division area that includes no data points in the initial selection of a representative point of the step (a). In the step of (a), a second central dividing point can be provided for the division areas diagonally facing the respective division areas that include no data points so that a representative point can be selected in a subsequent selection process to the initial selection process.

In the method according to the embodiments, the central dividing point may be set one of a center of the distribution of the distribution of data points and a centroid of the distribution of the distribution of data points. In this manner, an appropriate central dividing point may be automatically set for each of the plural data without making an operator to set the central dividing point.

In the method according to the embodiments, the representative point is selected by selecting a data point having a shortest distance from the first central dividing point as another representative point in each of the division areas in the step of (a). Accordingly, the distribution area of the data points may appropriately expressed even if the central dividing point is situated outside of an outer circumferential line obtained by connecting the all the data points in the scatter diagram.

In the method according to the embodiments, a case where the distribution area representing line is desired to be plotted without connecting the aforementioned three unique data points in the method for plotting a distribution area, the method further includes (c) grouping data points having a distance therebetween equal to or shorter than a predetermined distance threshold before carrying out the step of (a), and the steps of (a) and (b) are carried out on each group set in the step of (c), thereby appropriately expressing the distribution area of the data points. In addition, the steps of (a) and (b) are carried out on one of the groups that includes a largest number of data points. In this manner, the distribution area of the data points may appropriately plotted without including an abnormal data distribution of data points.

Further, in the step of (b), virtual representative points are each provided corresponding to each of the representative points in a direction in which an outline of the distribution the data points is expanded by a predetermined range, and the distribution area representing line is plotted by sequentially connecting the provided virtual representative points. In this manner, the representative point and the distribution area representing line may be prevented from being displayed with overlaps. For example, in a case where a center of a defective chip group composed of plural chip areas disposed in a matrix-type configuration on a semiconductor wafer is represented on the scatter diagram, virtual representative points are each provided corresponding to each of the representative points in a direction in which an outline of the distribution the data points is expanded by a predetermined range, and the distribution area representing line is plotted by sequentially connecting the provided virtual representative points. In this manner, the representative points representing an entire chip area may be disposed within the distribution area representing line to make it easy to discriminate the defective chip portion.

In the method according to the embodiments, since a data point having a longest distance from the first central dividing point in each of the division areas is selected as a representative point of the distribution of data points, the distribution area of two paired variables of data can be clearly outlined by the distribution area representing line. Accordingly, the correlation between the two types of data and two types of distribution areas may be clearly differentiated. Thus, the method for plotting a distribution area according to the embodiments of the invention is particularly effective in expressing two or more types of data points in overlapped layers in the scatter diagram.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiment of the present invention has been described in detail, it should be understood that various changes, substitutions, and alterations could be made hereto without departing from the spirit and scope of the invention.

This patent application is based on Japanese Priority Patent Application No. 2008-279466 filed on Oct. 30, 2008, the entire contents of which are hereby incorporated herein by reference.

What is claimed is:

1. A method for plotting a distribution area of a plurality of data points each having two paired variables in a scatter diagram, the method comprising:
(a) dividing a distribution of data points into at least two division areas in one or more radial directions of the distribution of data points from an arbitrary first central dividing point and selecting a data point having a longest distance from the first central dividing point in each of the division areas as a representative point of the distribution of data points; and
(b) plotting a distribution area representing line by sequentially connecting the selected representative points in respective division areas.

2. The method as claimed in claim 1, wherein
in the step of (b), the distribution area representing line is plotted by sequentially connecting the selected representative points in an order such that the plotted distribution area representing line has no intersection.

3. The method as claimed in claim 1, wherein
in the step of (a), the first central dividing point is one of a center of the distribution of data points and a centroid of the distribution of data points.

4. The method as claimed in claim 1, wherein
in the step of (a), provided that there is a division area that includes no data point, the first central dividing point is selected as a representative point in the division area that includes no data point.

5. The method as claimed in claim 1, wherein
in the step of (a), in a case where a regression line through the data points is further provided, a line to define the division areas is set so as to form a predetermined angle to the regression line.

6. The method as claimed in claim 1, wherein
in the step of (a), after the selection of the representative point in the each of the division areas, in a case where the at least two division areas that are adjacently arranged are set as examination areas, a data point having a vector having the first central dividing point as an origin and one of the data points as an end point and having a greatest magnitude of a vector component in a direction of a dividing line dividing the distribution of data points into the at least two division areas and extending from the first central dividing point is selected as an additional representative point in the examination areas among the data points each having a vector having the first central dividing point as an origin and each data point as an endpoint and each having a greater magnitude of a vector component in the direction of the dividing line dividing the distribution of data points into the at least two division areas and extending from the first central dividing point than any one of the representative points in the examination areas.

7. The method as claimed in claim 6, wherein
in the step of (a), in a case where there are two or more data points each having the greatest magnitude of the vector component in the direction of the dividing line dividing the distribution of data points into the at least the two division areas and extending from the first central dividing point in the examination areas, one of the two or more data points that is located closest to the first central dividing point is selected as an additional representative point in the examination areas.

8. The method as claimed in claim 1, wherein
in the step of (a), after the selection of the representative point in the each of the division areas, in a case where there are a plurality of dividing lines each dividing the distribution of data points into a plurality of division areas and each extending from the first central dividing point, a data point having a vector having the first central dividing point as an origin and the data point as an endpoint and having a greatest magnitude of a vector component in a corresponding one of directions of the dividing lines each dividing the distribution of data points in the plurality of division areas and extending from the first central dividing point is selected as an additional representative point in the corresponding one of the directions of the dividing lines each dividing the distribution of data points into the plurality of division areas and extending from the first central dividing point, among the data points each having a vector having the first central dividing point as an origin and each data point as an endpoint and each having a greater magnitude of a vector component in the corresponding one of the directions of the dividing lines each dividing the distribution of data points in the plurality of division areas and extending from the first central dividing point than the representative point in the each of the division areas.

9. The method as claimed in claim 8, wherein
in the step of (a), when there are two or more data points each having the greatest magnitude of the vector component in the corresponding one of the directions of the dividing lines dividing the distribution of data points into the plurality of division areas and extending from the first central dividing point, one of the two or more data points that is located closest to the first central dividing point is selected as an additional representative point in the corresponding one of the directions of the dividing lines dividing the distribution of data points into the plurality of division areas and extending from the first central dividing point.

10. The method as claimed in claim 1, wherein
in the step of (a), an additional representative point is selected by applying a different value to the first central dividing point in a plurality of times.

11. The method as claimed in claim 10, wherein
in the step of (a), in a case where there is one of the division areas that includes no data point in an initial selection process of the representative point in the each of the division areas, a second central dividing point is provided at a position within a division area facing the one of the division areas that includes no data point so as to select the additional representative point in the one of the division areas that includes no data point in a subsequent selection process to the initial selection process of the representative point.

12. The method as claimed in claim 11, wherein
in the step of (a), the second central dividing point is set as one of a center of the distribution of the distribution of data points and a centroid of the distribution of the distribution of data points in one of the selection processes of the representative point.

13. The method as claimed in claim 1, wherein
the step of (a) further includes selecting a data point having a shortest distance from the first central dividing point as another representative point in each of the division areas.

14. The method as claimed in claim 1, further comprising:
(c) grouping data points having a distance therebetween equal to or shorter than a predetermined distance threshold before carrying out the step of (a), wherein
the steps of (a) and (b) are carried out on each group set in the step of (c).

15. The method as claimed in claim 1, further comprising:
(c) grouping data points having a distance therebetween equal to or shorter than a predetermined distance threshold before carrying out the step of (a), wherein
the steps of (a) and (b) are carried out on one of the groups that includes a largest number of data points.

16. The method as claimed in claim 1, wherein
in the step of (b), virtual representative points are each provided corresponding to each of the representative points in a direction in which an outline of the distribution the data points is expanded by a predetermined range, and the distribution area representing line is plotted by sequentially connecting the provided virtual representative points.

17. A computer program product for causing a computer to execute the steps as claimed in claim 1 for plotting a distribution area of data points in a scatter diagram.
